(19) United States
(12) Patent Application Publication
(10) Pub. No.: US 2009/0108090 A1
(43) Pub. Date: Apr. 30, 2009

(54) QUANTITATIVE AEROSOL GENERATOR (QAG)

(75) Inventors: John A. Cooper, Beaverton, OR (US); Douglas C. Barth, Tigard, OR (US); Bruce E. Johnsen, Tigard, OR (US)

Correspondence Address: Goff Patent Law, 8000 NE PARKWAY DR., Suite 200, VANCOUVER, WA, 98662, US

(73) Assignee: Cooper Environmental Services LLC, Portland, OR (US)

(21) Appl. No.: 12/347,486

(22) Filed: Dec. 31, 2008

Related U.S. Application Data
(63) Continuation-in-part of application No. 11/183,244, filed on Jul. 14, 2005.
(60) Provisional application No. 60/643,799, filed on Jan. 14, 2005.

(51) Int. Cl. B05B 7/24

(52) U.S. Cl. 239/8; 239/411

(57) ABSTRACT

A liquid comprising an analyte can be nebulized to produce droplets, and the droplets can be entrained in a carrier fluid flow. A portion of the droplets can be selected to remain entrained in the carrier fluid flow, thereby producing a selected droplet fluid flow including the carrier fluid and the selected portion of the droplets. The selected droplet fluid flow can be dried to produce an aerosol flow containing particles comprising the analyte. In addition, an amount of the liquid consumed in producing the aerosol flow can be quantified.

### RELATED APPLICATIONS

This application is a continuation-in-part of U.S. patent application Ser. No. 11/183,244, filed Jul. 14, 2005, entitled Quantitative Aerosol Generator (QAG) Method and Apparatus; which is a Continuation-in-Part of U.S. Provisional Application No. 60/643,799, filed Jan. 14, 2005, entitled Quantitative Aerosol Generator (QAG) Apparatus and Method and Validation Method Using the QAG. Both of these applications are incorporated herein by reference.

### TECHNICAL FIELD

The description relates to a quantitative aerosol generator.

### BACKGROUND

Continuous emissions monitoring systems are often used to monitor emissions from a stack. Emissions are typically monitored to demonstrate compliance with emissions standards. It would be useful to be able to generate an aerosol with a known concentration that can be used to verify the accuracy and precision of continuous emissions monitoring systems.

### SUMMARY

The described embodiments can address the need described above, although they may be useful in addressing one or more other needs in addition to, or instead of, addressing this need. For example, the described embodiments may be used to produce an aerosol from a continuous flow of liquid having an unknown concentration of one or more analytes. The aerosol can then be analyzed using standard aerosol analysis techniques to determine the concentrations of the analytes in the aerosol, and the resulting information can be used to calculate the concentration of the analytes in the liquid flow.

According to one embodiment, a liquid comprising an analyte can be nebulized to produce droplets, and the droplets can be entrained in a carrier fluid flow. A portion of the droplets can be selected to remain entrained in the carrier fluid flow, thereby producing a selected droplet fluid flow including the carrier fluid and the selected portion of the droplets. The selected droplet fluid flow can be dried to produce an aerosol flow containing particles comprising the analyte. In addition, an amount of the liquid consumed in producing the aerosol flow can be quantified.

According to another embodiment, a source of a liquid includes an analyte. A measurement device can be configured to measure a quantity of the liquid consumed by an aerosol generation apparatus. A nebulizer system in communication with the source of liquid can include a droplet generation chamber. A mixing region can be configured to mix the carrier fluid with droplets generated by the nebulizer to form an aerosol flow containing droplets of the liquid entrained in the carrier fluid. A droplet selection system in communication with the mixing region can be configured to receive the aerosol flow. Moreover, a drying system in communication with the droplet selection system and adapted to receive the aerosol flow therefrom can include a heater adapted to heat and dry the aerosol flow.

According to yet another embodiment, a solution, which includes a component therein, is provided. A plurality of liquid droplets containing the component is formed by applying one or more ultrasonic waves to the solution. The liquid droplets can be passed through a droplet size selection system, and a first portion of the liquid droplets can be dried to evaporate liquid therefrom.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a schematic view of a quantitative aerosol generator apparatus.

FIG. 2 is a more detailed schematic view of the quantitative aerosol generator depicted in FIG. 1.

FIG. 3A is a schematic view of the nebulizer shown in FIGS. 1 and 2.

FIG. 3B is a schematic view of the nebulizer and droplet generation chamber shown in FIGS. 1 and 2.

FIG. 4 is a schematic view of the droplet size-selection chamber of the quantitative aerosol generator shown in FIGS. 1 and 2.

FIG. 5 is a schematic view of another quantitative aerosol generator apparatus.

FIG. 6 is a more detailed schematic view of the quantitative aerosol generator of FIG. 5.

FIG. 7 is a schematic view of the solution control system of the quantitative aerosol generator of FIG. 5.

FIG. 8 is an exploded schematic view of the nebulizer system, size selection system, and the focusing and transport interface of the quantitative aerosol generator of FIG. 5.

FIG. 9 is a view similar to FIG. 8, but in assembled form.

FIG. 10 is a schematic view illustrating the nebulizer system and the droplet selection system of the quantitative aerosol generator of FIG. 5.

FIG. 11 is a schematic view of the carrier air control system of the quantitative aerosol generator of FIG. 5.

FIG. 12 is a sectional view of the focusing and transport interface, as well as the top of the settling chamber and the bottom of the drying residence chamber, of the quantitative aerosol generator of FIG. 5.

FIG. 13 is a schematic view of the cooling air control system of the quantitative aerosol generator of FIG. 5.

FIG. 14 is a schematic view of the drying air control system of the quantitative aerosol generator of FIG. 5.

FIG. 15 is a schematic view of the make-up air control system of the quantitative aerosol generator of FIG. 5.

The description and drawings may refer to the same or similar features in different drawings with the same reference numbers.

### DETAILED DESCRIPTION

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

A number of terms will be used throughout to describe the invention. Among those terms, the following are defined as follows:

Accuracy: The agreement between an experimentally determined value and an accepted reference value.

Analyte: Element of interest in the analysis, e.g., As, Cd, Cr, Pb and Hg.

Analyte Line: X-ray emission line used to quantify the analyte.

Attenuation: Reduction of X-ray intensity due to energy dissipation in filter and deposit.

Calibration: The process of comparing a sampling or instrumental response with a known parametric value for the purpose of obtaining a quantitative relationship between the response and the parametric value that can be used to determine the parametric value for an unknown sample.

Detection Limit: The smallest concentration that a particular measurement can detect.

EDXRF: Energy dispersive X-ray fluorescence.

EPA Practical Limits of Quantitation: The lowest level above which quantitative results may be obtained with an acceptable degree of confidence.

Interference: An undesired positive or negative output caused by a substance other than the analyte.

Limit of Detection: Lowest concentration that can be detected by an instrument without correction for the effects of sample matrix or method-specific parameters such as sample preparation.

Limit of Quantitation: Lowest concentration that can be reliably achieved within specified limits of precision and accuracy during routine laboratory operating conditions.

NIST: National Institute of Standards and Technology.

Precision: The degree of mutual agreement between individual measurements of a parameter having the same value, namely repeatability and reproducibility.

Relative Percent Standard Deviation: The standard deviation of a set of measurements divided by the mean of the set of measurements times 100.

SRM: Standard Reference Materials.

Standard Deviation: The square root of the variance, or the precision of repeated measurements.

Standard: A value for a parameter that has been established by authority, custom, or agreement to serve as a model or rule in the measurement of quantity or the establishment of a practice or procedure.

Traceability to NIST: A documented procedure by which a measured response is related to a standard with an accuracy defined by and certified by the National Institute of Standards Technology (NIST).

Uncertainty: A statistically defined value associated with a single measurement or a value associated with a group of measurements that defines the range and probability of additional measurements falling within the defined range, and can include allowance for both systematic and random sources of error.

Unknown: A sample submitted for analysis whose elemental concentration is not known.

XRF: X-ray fluorescence.

In one embodiment, an aerosolized metal is produced by a Quantitative Aerosol Generator (QAG), which uses a Collison nebulizer to combine cooled and saturated air with a NIST-traceable solution of a known concentration of a metal of interest. The aerosol containing the metals is then dried and transported in an entraining air stream for analysis by XRF or other analytical methods. In one embodiment, the QAG has demonstrated applicability to auditing the measurement of metals (such as metals in stack gas) ranging from magnesium (Mg, atomic number 12) to uranium (U, atomic number 92) on the periodic table in a concentration ranges from five to one thousand micrograms per cubic meter (5-1000 μg/m³). The QAG's precision at concentrations of about 100 μg/m³ can be +/−2% with an accuracy of 5%. This represents a significant advance over known methods, which are normally not able to provide a precision of less than about 20%.

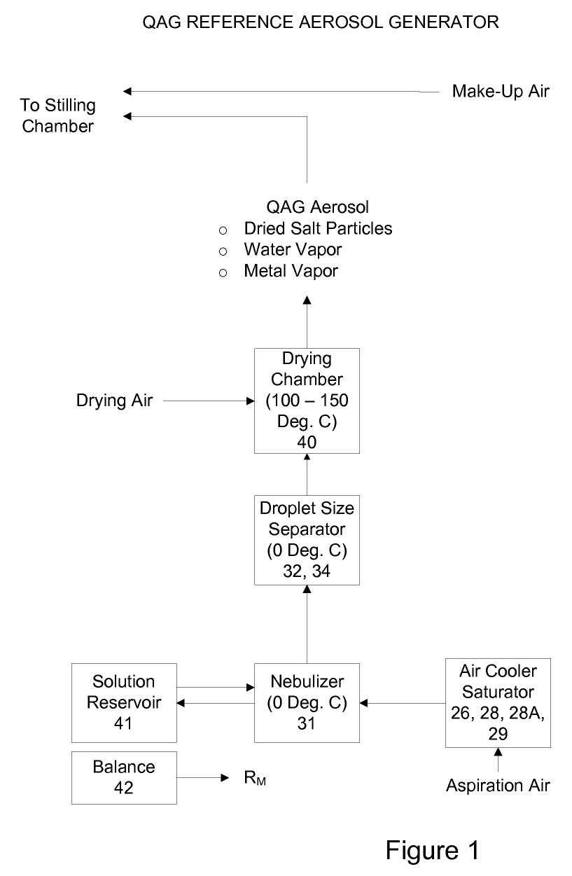

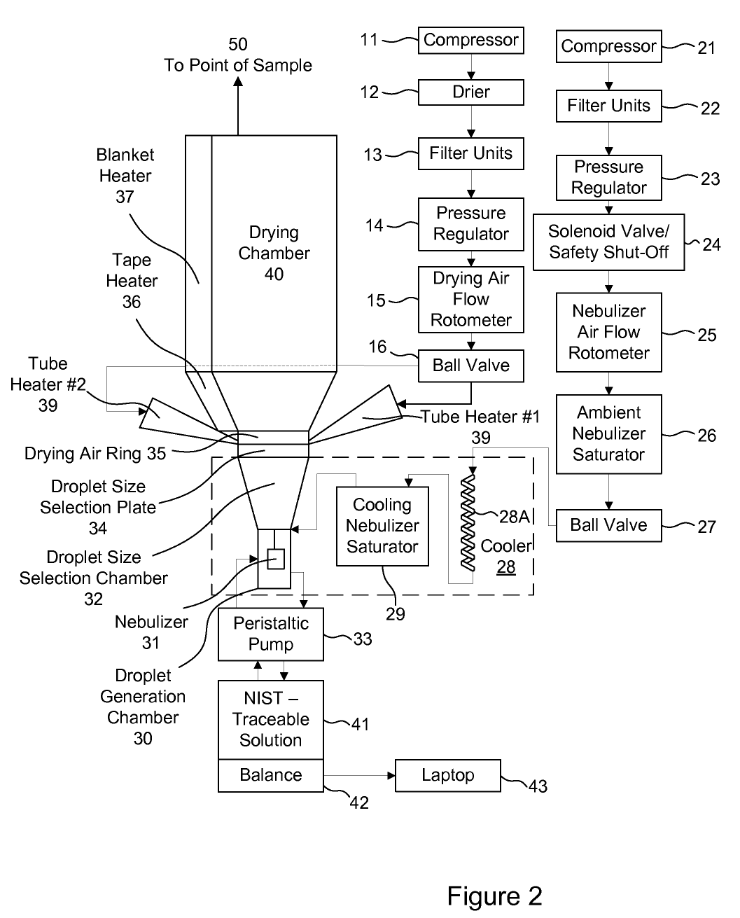

An embodiment of a quantitative aerosol generator (QAG) is described in more detail with reference to FIGS. 1 and 2. The QAG generates an aerosol from a solution containing one or more analytes. A relatively large amount of the solution is provided in a solution reservoir (41). The solution and solution reservoir (41) are placed on a balance (42). The balance (42) is used to measure the mass of the solution in the reservoir (41). A computer (43) records the changing mass of the solution in the reservoir (41), as reported by the balance (42). A peristaltic pump (33) circulates the solution between the droplet generation chamber (30) and the reservoir (41). The use of a relatively large solution reservoir (41) can be advantageous because the relatively large amount of solution can allow for a minimal concentration change due to loss of water vapor.

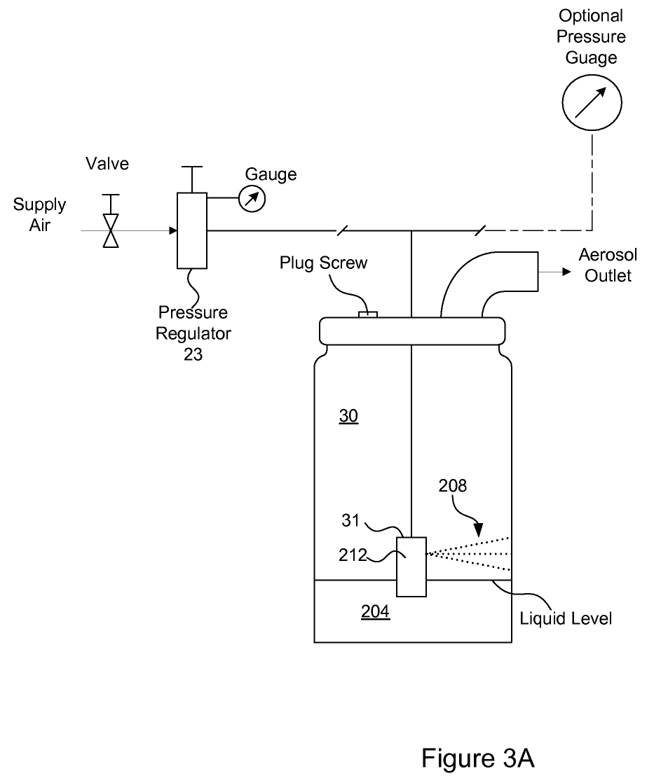

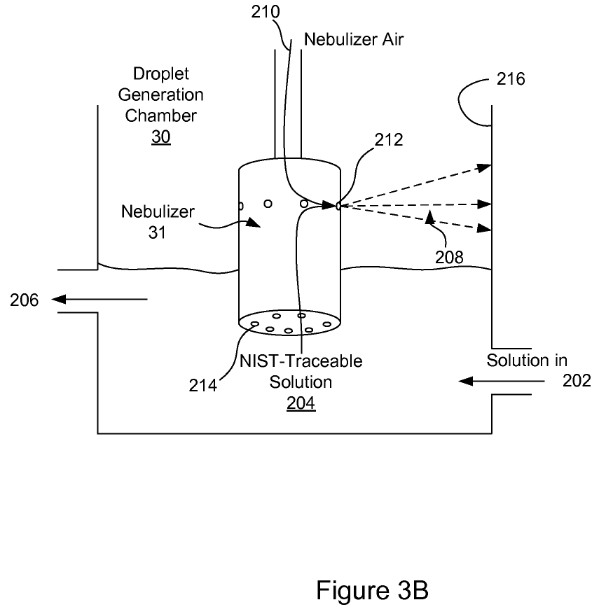

The droplet generation chamber (30) and the nebulizer (31) will be discussed in more detail with reference to FIGS. 3A-3B. The amount of solution flowing into the droplet generation chamber (30) via inlet (202) is more than the amount of solution flowing out of the droplet generation chamber (30) via outlet (206) to make up for the solution that passes through to the drying chamber (40). Therefore, the depth of the solution (204) in the droplet generation chamber can remain roughly constant. The solution of interest (204) is aerosolized by a Collison nebulizer (31) located within the droplet generation chamber (30). Nebulizer air, which is generated by a method that will be described in greater detail below, enters the nebulizer (31) at inlet (210). The air is forced through the nebulizer (31) and out into the droplet generation chamber (30) via small holes (212) in the side of the nebulizer (31). The total flow rate of the resulting aerosol can be changed by changing the number of small holes (212) in the side of the nebulizer (31). For example, nebulizers with 1, 6, or 12 small holes may be used to achieve a desired total flow rate of the resulting aerosol. A bottom portion of the nebulizer (31) can be submerged in the solution (204) and the force of the nebulizer air as it is pushed out of the holes (212) can draw the solution (204) up through small holes (214) at the bottom of the nebulizer (31). The liquid spray (208) exiting the nebulizer (31) can collide with the side (216) of the droplet generation chamber (30), and the force of the impact can create aerosolized liquid droplets.

A method for generating nebulizer air will be described with reference to FIG. 2. Air generated by compressor (21) is directed through filter units (22) in order to remove any undesirable contaminants, such as oil, from the air. In one embodiment, at least 20 psi and 50 slpm (2 cfm) of instrument air is provided. Two air compressors (11, 21) can be used to push air through the QAG in order to aerosolize the metal-containing NIST-traceable solution. The air generated by the first compressor (21) can be directed to the Collison nebulizer at a rate of approximately 13 slpm. This air, hereafter referred to as “nebulizer air,” can be combined with the NIST-traceable solution to create the aerosolized metals. The air generated by the second compressor (11), hereafter referred to as “drying air,” can be used to help dry the aerosolized metals and can be directed into the drying chamber (40) at a rate of approximately 34 slpm. The drying air can be actively dried with a refrigerated compressed air dryer such as those manufactured by Speedair.

A pressure regulator (23) can be used to control the pressure of the nebulizer air flowing into the QAG system. A solenoid valve (24) can serve as a safety shut-off switch, so that the QAG can be shut down if the flow rate of the main exhaust drops below a given set point. A rotometer (25) can measure the flow rate of the nebulizer air. An ambient nebulizer air saturator (26) can be a bubbler containing distilled water. The nebulizer air can be diffused into the water through a small filter so that the air leaving the air saturator (26) is saturated at room temperature. A ball valve (27) can be used as a shut-off valve for the nebulizer air. The nebulizer air can then be passed through a heat exchanger (28A) within a cooler (28) containing an ice bath in order to cool the nebulizer air to 32 degrees F. A cooling nebulizer saturator (29), droplet generation chamber (30), nebulizer (31), and droplet size-selection chamber (32) can all be housed within the cooler (28).

Following the heat exchanger (28A), the nebulizer air can be passed through the cooling nebulizer saturator (29), which saturates the nebulizer air at 32 degrees F. The cooling nebulizer saturator (29) can be similar to the ambient air saturator (26). The cold, saturated nebulizer air then flows to the nebulizer (31) through inlet (210) (see FIG. 3B), as described above with reference to FIGS. 3A-3B. It is preferable that the nebulizer air be cold and saturated in order to allow for accurate calculation of the loss of water vapor.

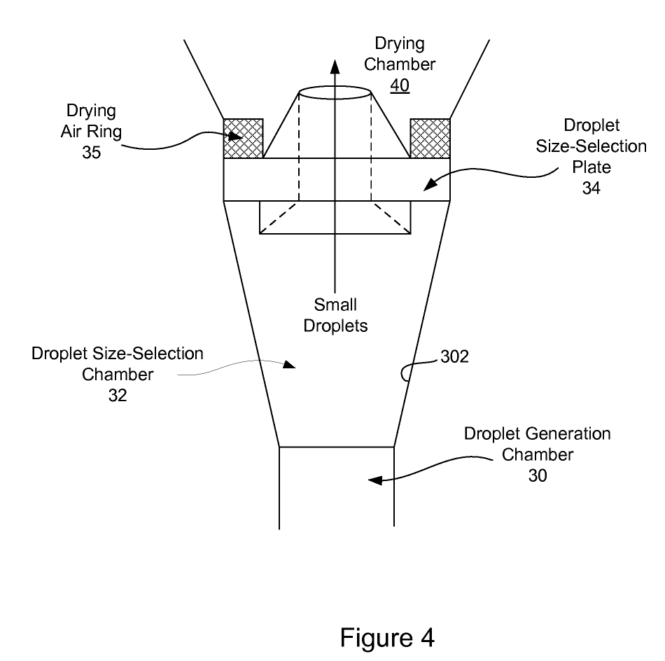

After collision against the side (216) of the droplet generation chamber (30), the aerosolized liquid droplets can pass out of the droplet generation chamber (30) and into the droplet size-selection chamber (32). The droplet size-selection chamber (32) is shown in more detail in FIG. 4. In the droplet size-selection chamber (32), small droplets of aerosol pass through the droplet size-selection plate (34) and into the drying chamber (40). The droplet size-selection plate is designed to allow only small droplets to pass through into the drying chamber (40). The plate includes a PTFE gasket and PTFE funneling piece. Large droplets impact the side (302) of the chamber (32), impact the droplet size-selection plate (34) at the top of the chamber (32), or fall back into the droplet generation chamber (30) due to a lack of force. All large droplets are recovered in the solution (204) (FIG. 2) at the bottom of the droplet generation chamber (30). The droplet size-selection chamber (32) allows control of the size of the resulting analyte particles. This prevents the generation of large particles that might be lost in the transport system and thus contribute to uncertainty in the resulting aerosol concentration. In other embodiments, the droplet size-selection chamber (32) may use cyclonic or plate impaction.

Referring to FIGS. 2 and 4, drying air, which is described in greater detail below, and the flow of nebulized liquid droplets and nebulizer air are combined in the drying chamber (40), which can be heated to approximately 350 degrees F. The droplets can be dried in the chamber (40), and the resulting aerosol can then be transported from the chamber (40) to a sampler via outlet (50). The drying chamber (40) can be heated by a tape heater (36) and a blanket heater (37). A temperature controller can maintain the temperature of the heaters at approximately 350 degrees F.

Referring to FIG. 2, the method for generating the drying air will be described in more detail. The air generated by the compressor (11) can be directed through a drier (12), where the air can be actively dried with a refrigerated compressed air dryer. The drying air can then be passed through filter units (13) in order to remove any undesirable contaminants, such as oil, from the drying air. A pressure regulator (14) can control the flow rate of the drying air, which can be measured by a rotometer (15). A ball valve (16) can be used as a shut-off valve for the drying air. The drying air can then split into two lines downstream of the drying air ball valve (16) and each line can be passed through a tube heater (39) just before the air enters the drying chamber (40). The tube heaters (39) can be maintained at 300 degrees F. by temperature controllers. After being heated by the tube heaters (39), the drying air can enter the drying chamber (40) through the drying air ring (35). The drying air ring (35) can be located just above the droplet size-selection plate (34), and the air can enter the drying chamber (40) through a series of holes in the ring (35). The drying air increases the drying rate of atomized droplets and acts as a sheath that keeps the droplets from hitting the chamber walls.

The drying air, nebulizer air, and the solution flow from their sources to the other QAG components via PFA and stainless steel tubing. All of the saturators, chambers, and the nebulizer used in the QAG can be stainless steel. The saturators can be lined with PFA to prevent corrosion. The drying chamber and some of the post-drying chamber transport components can be insulated with 1-inch thick fiber glass. Any parts that come into contact with the drying air, nebulizer air, solution, and the aerosol can be corrosion resistant.

In a first embodiment, the QAG described above generates an aerosol with a known concentration of a desired analyte. In this embodiment, the solution in the reservoir (41) has a known concentration. The concentration of the aerosol can then be calculated as follows:

$${C}_{N} = \frac{( {w}_{i} - {w}_{f} ) {S}_{s} E}{v} \qquad ( Equation 1 )$$

where:

C_{N}=Aerosol concentration.

Wᵢ=Initial weight of the reference solution reservoir (before pump (33) is turned on).

W_{f}=Final weight of the reference solution reservoir (after pump (33) is turned on and equilibrium is reached).

Cₛ=Concentration of the analyte in the solution.

E=Aerosol generation and transport efficiency.

V=Volume of nebulizer air and drying air.

The aerosol generation and transport efficiency can be calculated as follows:

$$E = \frac{{M}_{t}}{( {W}_{i} - {W}_{f} ) {C}_{s}} \qquad ( Equation 2 )$$

where:

Mₜ=The total mass collected when the QAG-generated and transported aerosol is sampled at the QAG outlet (50).

An aerosol with a known concentration is useful for several applications, including verifying the accuracy and precision of a sampling method. For example, an aerosol with a known concentration can be used to verify the accuracy and precision of a continuous emissions monitoring system.

In another embodiment, the QAG generates an aerosol with an unknown concentration of an analyte. In this embodiment, the solution in the reservoir (41) has an unknown concentration. Using a known sampling method, the concentration of the aerosol can be determined and the concentration of the solution can be calculated using the above equations.

A third embodiment is similar to the second embodiment, except that the solution with an unknown concentration is not contained in a reservoir. The solution is continuously flowing through the QAG system via the inlet (202) and outlet (206) in the droplet generation chamber (30) (see FIG. 2). This embodiment has several applications, including continuous monitor of species in such solutions as drinking water or process effluents. In this embodiment, the pump (33), reservoir (41), balance (42) and computer (43) can be bypassed or eliminated from the QAG system. In this third embodiment, quantitation of analytes in the continuously-flowing solution can be achieved by continuously spiking the solution with a non-interfering internal standard (i.e., an internal tracer solute), such as palladium (Pd).

The QAG optionally comprises an aerosol form modifier (not shown) at the outlet (50) of the QAG. The form modifier treats the resulting aerosol with conditioners to modify the resulting aerosol. For example, a charge neutralizer (such as krypton (Kr) 85, polonium (Po) 210, or praseodymium (Pr) 147), catalysts, or combustion chambers could be introduced downstream of the QAG to impart different characteristics to the aerosol, or other aerosols, gases or vapors could be blended downstream of the QAG. For example, the addition of an alternative flow pattern downstream of the QAG could direct the QAG generated aerosol through a catalyst that might convert a mercuric chloride aerosol or a mercuric nitrate aerosol from its ionic form to its elemental form to evaluate the performance of mercury measurement instruments and their response to different forms of mercury.

The particle size of the aerosol generated by the QAG can be adjusted by adjusting the parameters of the droplet-size selection chamber (32). Additionally, the particle size can be adjusted by adjusting the solution concentrations. Because of the potential to control the particle size of the aerosol, it is possible to use the QAG for particle size and transport studies as well as other research projects.

The QAG may additionally be applicable in areas such as inorganic or organic analytes, aqueous or non-aqueous solutions and generation of aerosols of varying particle sizes.

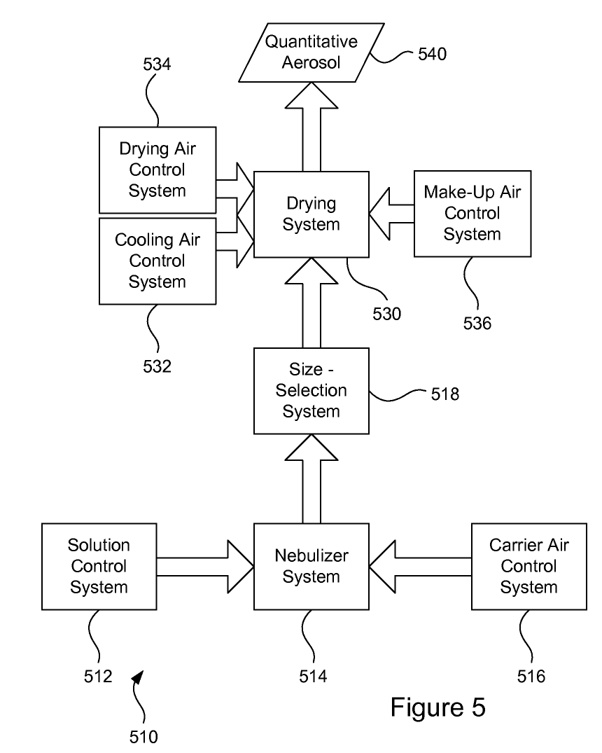

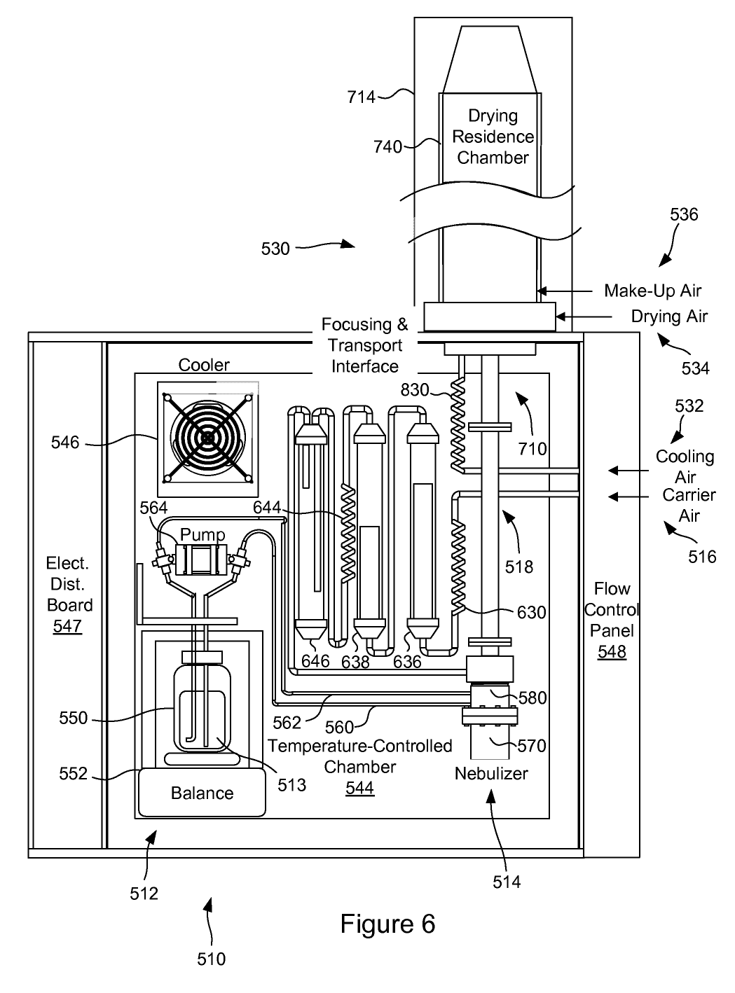

Referring now to FIGS. 5-6, another embodiment of a QAG (510) is illustrated schematically. The QAG (510) can be used with a solution source reservoir having a solution of known or unknown concentration, or with a continuous solution flow source of known or unknown concentration, as discussed above with reference to the QAG embodiment of FIGS. 1-4. FIG. 5 illustrates the systems and the flow of fluids through the QAG (510), while FIG. 6 illustrates the apparatus schematically. A solution control system (512) introduces a liquid solution (513) into a droplet generation system such as a nebulizer system (514), which produces droplets of the liquid solution. Carrier air introduced from a carrier air control system (516) can carry the droplets through a size selection system (518), where droplets that are too large can be impeded and allowed to drain back into the liquid solution (513). The carrier air and the droplets that pass through the size selection system (518) can be passed through to a drying system (530). The drying system (530) can receive additional air, such as cooling air from a cooling air control system (532), drying air from a drying air control system (534), and make-up air from a make-up air control system (536). The drying system (530) can also receive heat from one or more heaters. The drying system (530) can produce a dried quantitative aerosol (540) that includes particles (typically salts) containing the solute from the solution (513) of the solution control system (512).

Referring to FIG. 6, some parts of the QAG (510) can be housed in a temperature-controlled chamber (544), which also includes a standard cooler (546) to keep the temperature-controlled chamber (544) substantially at a predetermined temperature. The temperature in the temperature-controlled chamber (544) can be a temperature that allows components within the chamber to operate properly and does not freeze or produce too much evaporation from the solution (513) in the solution control system (512). For example, the temperature can be from about 40 degrees F. to about 95 degrees F., with lower temperatures typically being better for reducing evaporation. The temperature could be even lower that 40 degrees F. if the components in the chamber will still operate correctly and the solution (513) will not freeze. The temperature-controlled chamber (544) can be surrounded by standard insulation, such as two-inch thick insulation. Localized coolers, such as in-line coolers could be used in the apparatus in addition to, or instead of, the cooling effect of the temperature-controlled chamber. For example, the return line for the solution (discussed below) could include an in-line cooler to remove heat added by the solution pump (discussed below) and the nebulizer system (514).

Some standard electrical components of the QAG (510) can be housed in a standard electrical distribution board (547) for distributing electricity to electricity-consuming components of the QAG (510), such as electronic balances, electric pumps, and electrically-powered nebulizer components. In addition, many components of the flow control systems discussed below can be housed in the flow control panel (548). The parts of the QAG (510) may be split into modular components, such as a temperature controlled component including the temperature-controlled chamber (544), a heating component including heated components of the drying system (530), a flow control component including the flow control panel (548), and an electrical distribution component including the electrical distribution board (547).

Selection of the type of solution (513) can depend on the desired aerosol characteristics, as defined by the application of the QAG (510). For instance, if the QAG (510) is being used to deliver an aerosol containing a salt that will be used to challenge and calibrate a particulate matter monitor, then the solution (513) may include a solute that fits the following criteria: (1) contains no waters of hydration; (2) is non-deliquescent; (3) is non-hygroscopic; and (4) has high solubility in solution (such as about 10% or higher, about 30% or higher, or about 50% or higher). Potassium Iodide is an example of a salt that fits the above criteria and would be useful if the total air inflow of the monitor being calibrated or audited is generated by the QAG (510). If the QAG is being used to spike a reactive gas stream (i.e. stack gas), then the solute can also be non-chemically reactive with the components of the gas stream. Two examples of solutes for this application are Potassium Sulfate and Rubidium Sulfate.

The solution concentration can be determined based on the desired resulting salt particle diameter in the aerosol (540), as determined by the equations discussed below, as it is believed that the salt diameter is proportional to the cube root of the solution concentration.

The solution control system (512) could continuously provide solution (513), with the QAG (510) continuously producing the quantitative aerosol (540). In such an embodiment, an internal tracer solute could be used to measure a quantity of the liquid consumed by the QAG (510) in the form of a flow rate, and thus the aerosolization rate of the QAG (510). In a continuous aerosol generator, a solution reservoir could be omitted. Instead, a constant flow of solution could be supplied to the nebulizer system (514) quantitatively with metering pumps. A known amount of internal tracer solute of known concentration could be added to the solution stream just before the solution reaches the nebulizer system (514). The internal tracer could be a compound that is easily analyzed by the same instrumentation as the analyte of interest, and has the same resulting particle size as the analyte. Because the tracer and analyte could be nebulized and transported in the same proportion, the tracer mass determined by the analyzer could be related to the analyte mass determined by the analyzer. It is believed that this relationship could be used to determine the analyte concentration in solution.

For example, if 9 ml/min of a solution were being introduced to the QAG to produce an aerosol to be tested for lead (Pb) concentration (the analyte), 1 ml/min of a tracer solution containing 1 ppm palladium (Pd) (the tracer mass) could be introduced into the stream just before it reaches the nebulizer system (514). Accordingly, the solution entering the nebulizer system (514) would contain 0.1 ppm Pd and an unknown concentration of Pb. If the aerosol (540) from the QAG were analyzed and found to contain 25 μg/m³ of Pd and 1 μg/m³ of Pb, then it would be known that the concentration of Pd is 25 times greater than the concentration of Pb. Accordingly, the concentration of Pb in the solution entering the QAG would have been 1/25th the concentration of Pd, or 0.004 ppm in the 10 ml/min solution. Thus, assuming no Pb was present in the tracer solution, the Pb concentration in the original 9 ml/min solution would have been 0.00 4̅4̅ ppm.

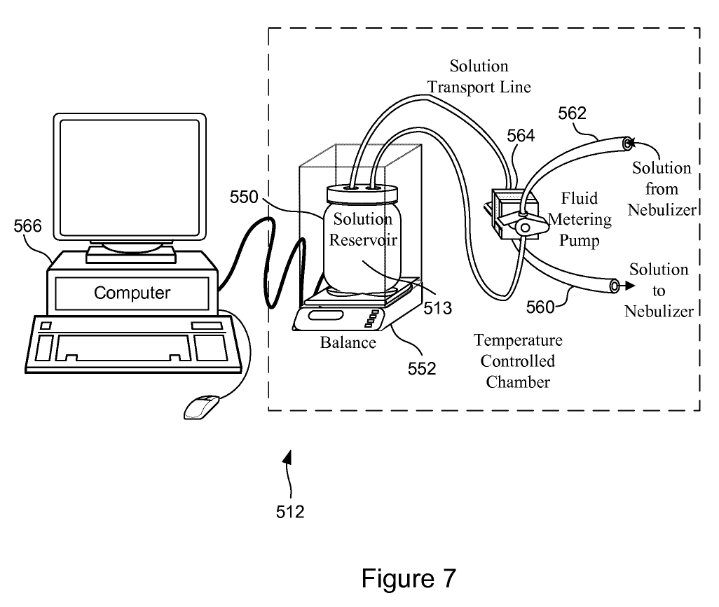

FIGS. 6-7 illustrate a QAG (510) where the solution control system (512) includes a solution reservoir (550) (such as where a known concentration in a solution is being used to produce an aerosol having a known quantity to verify air monitoring systems) holding the solution (513). The solution reservoir (550) can rest on a balance (i.e., a scale) (552), such as an electronic scale. The solution reservoir (550) can be large enough to minimize changes in concentration of solution from effects such as evaporation, and small enough to fit completely and securely on a pan of the balance (552). The reservoir (550) can be made of a non-corrosive material that will not contaminate the solution with the same materials that are being analyzed. For example, the reservoir (550) can be a standard glass reservoir or a rigid polymer reservoir, or even a plastic bag.

The solution control system (512) can also include a pair of solution transport lines (560 and 562). Specifically, a supply solution transport line (560) can lead from the reservoir (550) to the nebulizer system (514) to supply solution (513) to the nebulizer system (514). In addition, a return solution transport line (562) can lead from the nebulizer system (514) back to the reservoir (550). The solution transport lines (560 and 562) can be made of corrosive-resistant material, such as perfluoroalkoxy (PFA), 316 stainless steel, 316 stainless steel coated with PFA, or other similar materials. As with the reservoir (550), it is desirable for the lines to be some material that will not introduce significant quantities of the same materials that are being analyzed in the aerosol (540) that is being emitted from the QAG (510). The return solution transport line (562) can be curved at its end so that solution (513) entering the reservoir (550) from the return solution transport line (562) does not create significant downward forces that could disrupt measurements of the balance (552).

The solution transport lines (560 and 562) can pass through a pump (564), which can pump desired amounts of the solution (513) through the transport lines (560 and 562). For example, the pump (564) can be a two-headed metering pump that circulates the solution (513) between the solution reservoir (550) and the nebulizer system (514). The pump (564) can be set so that more solution (513) is passing through the supply transport line (560) than is being consumed by the QAG (transported to the drying system (530) in the form of droplets).

The balance (552) can quantify or measure the mass of the solution (513) being emitted by the QAG (510), which is the same as the drop in mass of the reservoir (550), so long as the amount of solution elsewhere in the QAG (510) (such as in the solution transport lines (560 and 562), the pump (564), and the nebulizer system (514)) remains constant. The balance (552) can be any balance that has sufficient precision to measure the difference in mass of solution (513) over time. It may be desirable for the balance (552) to output its results to a computer system (566) (see FIG. 7), which can record the changing mass of the solution (513) in the reservoir (550) over time using simple data recording software. These data can be used to determine the rate of reservoir mass loss, which is the slope of the recorded reservoir mass over time. The computer system may also perform standard calculations on the data, such as calculating moving averages (also called running or rolling averages) of the reservoir mass and performing standard curve fitting computations. In some embodiments, it may be desirable to have a computer system control the flow of fluids through the QAG (510). However, such control can be performed manually.

All the components of the solution control system (512) except the computer system (566) can be in the temperature-controlled chamber (544), and even the computer system (566) could be within the temperature-controlled chamber (544), if such a configuration were desired.

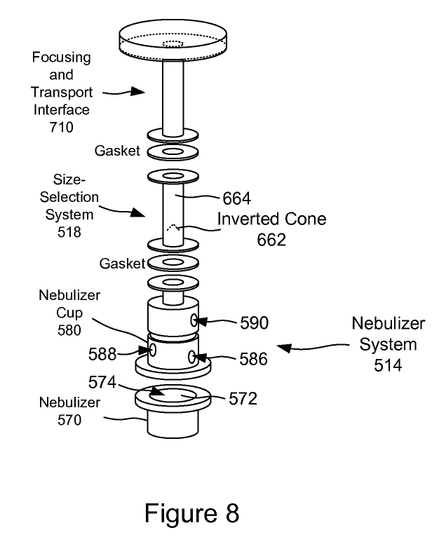

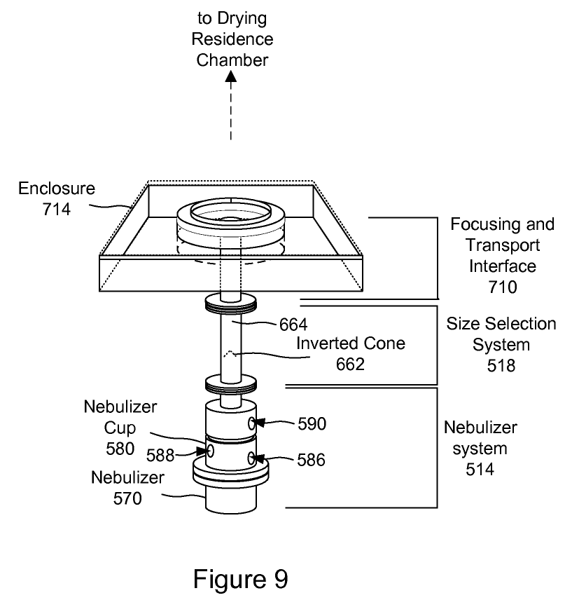

The nebulizer system (514) of this embodiment will now be described with reference to FIGS. 6 and 8-10. As noted above, the nebulizer system (514), or droplet generation system, can take any of several alternative forms. A Collison nebulizer was described in detail above with reference to previous embodiments. In the QAG (510) of the embodiments described here, an ultrasonic nebulizer system (514) can be used. The entire nebulizer system (514) can be housed within the temperature-controlled chamber (544).

A Collison nebulizer, such as the one described above, is an aspiration-impactor-type nebulizer. A correction factor, which is typically around 25%, is typically required to correct for vapor loss due to the use of compressed nebulizer air for impaction and changes in temperature of the air. The Collison nebulizer also typically generates a higher percentage of large droplets (those greater than 40 μm in diameter) than an ultrasonic nebulizer described below. The Collison nebulizer also typically produces more droplets in the range of about 30 μm in diameter (i.e., the approximate location of a peak of a droplet size histogram), while the ultrasonic nebulizer described below can typically produce the most fine droplets (i.e., the approximate location of a peak of a droplet size histogram) in the range of less than about 5 μm, and in some embodiments as low as about 0.6 μm or less.

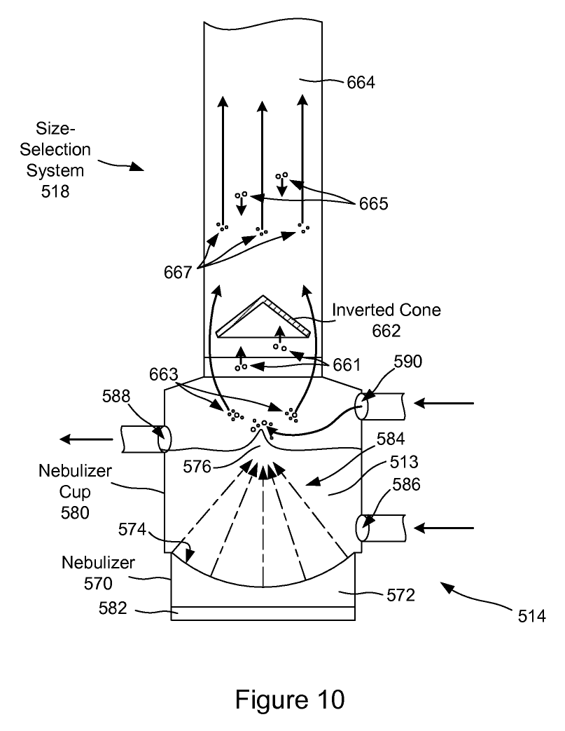

In this embodiment of the QAG (510), the nebulizer system (514) includes a focused ultrasonic nebulizer (570). The nebulizer (570) includes a lens (572), which can be a block of material with an upwardly-facing lens surface (574) that is a bowl-shaped concave surface. The concave surface (574) can be one of many different concave shapes, such as spherical, parabolic, or some combination thereof. Indeed, the surface (574) could be formed by numerous small planar surfaces arranged to form an overall concave surface, though a continuous concave surface (574) is typically preferable. It is typically desirable for the concave surface (574) to be oriented and shaped such that ultrasonic waves produced by vibrating the lens (572) are focused at a focusing region (576) (see FIG. 10) at or near the surface of liquid solution (513) within a nebulizer cup (580), extends up to house a reservoir of solution (513) in contact with the lens (572) and to serve as a droplet generation chamber. The lens (572) can be formed of a material that is able to be vibrated to transmit ultrasonic waves into a liquid. However, the material for the lens (572) is preferably a material that is durable and corrosive-resistant. It may also be desirable for the material for the lens (572) not to include significant amounts of the same materials as the analyte(s) from the solution (513), so that the lens (572) does not significantly alter the concentration of the analyte(s) in the solution (513). For example, the lens material can be made of a non-corrosive metal, such as titanium, that can be exposed to acidic solutions without significantly degrading over time.

A transducer (582) can be secured to the bottom of the lens (572), such as with an adhesive or in some other manner. The transducer (582) can be any of a variety of transducer types that can produce an ultrasonic vibration. In one embodiment, the transducer (582) can include a high power piezoelectric transducer ceramic that vibrates when an oscillating current is applied to it, thereby vibrating the lens (572) to produce ultrasonic waves (584) within the solution (513) in the nebulizer cup (580). It is believed that ultrasonic nebulization of the solution (513) occurs by unstable capillary waves (584) created by vibrating the lens (572) at or above the minimum amplitude required to eject droplets, as stated by a nebulizer manufacturer or determined by simple experimentation with different amplitudes for a particular configuration. Liquid droplets are sheared from the surface of the solution (513) via these ultrasonic waves (584). The nebulizer can be powered by a standard transformer and control module supplied with standard 110 AC voltages. The nebulizer (570) can be optimized for maximum nebulization efficiency by focusing the ultrasonic waves (584) at a region at or near the surface of the solution (513) within the nebulizer cup (580) with the nebulizer lens curvature and material design. As is illustrated in FIG. 10, the energy from the ultrasonic waves (584) can cause the solution (513) to rise at the focusing area, in addition to shearing droplets from the solution (513) in that region. The droplet size diameter generated can be determined based on the resonance of the material used. For example, the material can be such that it vibrates at a frequency of about 2.5 MHz. A large portion of the droplets generated by ultrasonic waves (584) at the surface of the solution (513) can be from about 0.1 μm to about 5 μm, or from about 0.6 μm to about 3 μm.

Referring to FIGS. 6-10, as noted above, the nebulizer cup (580) can contain the solution (513) to be aerosolized. This solution (513) can be continuously circulated between the nebulizer cup (580) and the external solution reservoir (550) (see FIG. 7) to allow for determination of the solution mass loss rate. The solution (513) can enter the nebulizer cup (580) from the supply solution transport line (560) of the solution control system (512) through a solution inlet port (586). A solution outlet port (588) can be positioned at the desired surface level of the solution (513) within the nebulizer cup (580) so that solution (513) at and above that level drains into the solution outlet port (588), thereby maintaining a desired fluid level within the nebulizer cup (580). The solution depth can be about one inch in one embodiment, although it could vary in different embodiments.

Carrier air can enter the nebulizer system (514) at a carrier air inlet port (590) in the nebulizer cup (580). The carrier air can be forced into the nebulizer cup (580) from the carrier air control system (516), causing the solution droplets created by the ultrasonic nebulizer (570) to be forced into the size-selection/equilibration system (518).

Referring to FIG. 10, it is desirable for the carrier air control system (516) to produce air, referred to herein as carrier air, which is used to carry the solution droplets from just above the solution surface to, and through, the size selection system (518). It is typically desirable for the compressed carrier air produced by the carrier air control system (516) to be saturated, and to be at the same temperature as the solution (513). However, it may be possible to correct for changes that would be introduced into the QAG (510) by non-saturated air and/or air that is at a different temperature than the solution (513).

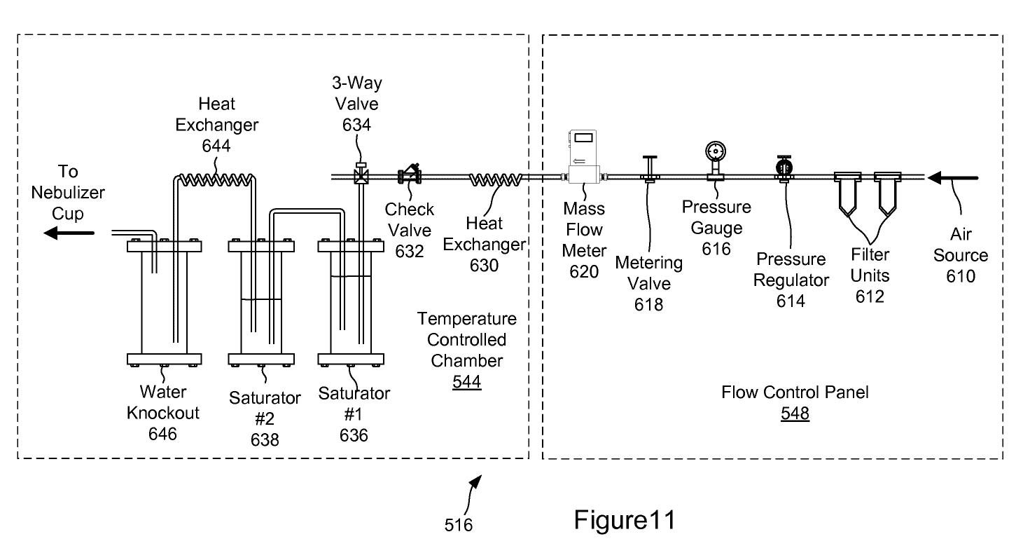

Referring now to FIG. 11, the carrier air control system (516) will now be described. Stainless steel, PFA or some other tubing can be used to transport the carrier air through the carrier air control system (516). The carrier air control system (516) can include a clean dry air source (610), such as an air compressor in a clean indoor room. The air from the air source (610) can be passed through a pair of standard air filter units (612) to clean the air. The filter units (612) can be filter units that can remove water, particulate and oil vapor from the carrier air. The carrier air can then be passed through a standard precision pressure regulator (614) to regulate the pressure of the air. The carrier air can then be passed through a standard pressure gauge (616) to allow a user to monitor the air pressure downstream of the pressure regulator (614), typically between 10 and 50 psi. The air can also be passed through a standard metering valve (618), which can be used to control the flow of carrier air entering the nebulizer system (514). A standard mass flow meter (620) can be used to measure and display the current mass flow of carrier air into the nebulizer system (514). With this information, a user can use the metering valve (618) to produce a desired mass flow rate of carrier air. Alternatively, a critical orifice device or some other device could be used to control flow. As will be discussed in more detail below, the carrier airflow rate can be altered to achieve a carrier airflow velocity through the size selection system (518) that exceeds a desired droplet settling velocity. The components of the carrier air control system (516) described above can be located outside the temperature-controlled chamber (544), such as in the flow control panel (548). The components described below can be located inside the temperature-controlled chamber (544).

The carrier air can be passed through a first heat exchanger (630) inside the temperature-controlled chamber (544) to bring the temperature of the carrier air to or near the temperature of the temperature-controlled chamber (544). The heat exchanger (630) and other heat exchangers described herein, can simply be a series of heat-conducting air lines wound in coils, or some other configuration. Alternatively, some other type of heat exchanger could be used, such as a heat exchanger including fins or other features to facilitate heat exchange between the carrier air and the air in the temperature-controlled chamber (544).

The carrier air can then be passed through a standard check valve (632), through a standard three-way valve (634), and through a pair of saturators (636 and 638). The check valve (632) can prevent back flow of water from the saturators (636 and 638), and the three-way valve (634) can be used to fill the saturators (636 and 638) with water. The saturators (636 and 638) can be standard bubblers with air passing through filters into the water in the saturators (636 and 638). The upstream saturator (636) can be about three-fourths-filled with water and the downstream saturator (638) can be half-filled with water. The carrier air can be pushed through the water in the saturators to assure saturation of the carrier air with water vapor. The saturators (636 and 638) can be checked periodically, such as once a day or more, and filled with water, such as distilled water, when necessary. The carrier air can also be passed through a second heat exchanger (644), which can be similar to the first heat exchanger (630), downstream of the saturators (636 and 638). The second heat exchanger (644) can be used to ensure the carrier air has equilibrated to the temperature of the temperature-controlled chamber (544) following saturation. The carrier air can then be passed through a standard water knockout (646), which can prevent water from the saturators (636 and 638) from entering the nebulizer cup (580).

Referring to FIG. 10, the carrier air can then be pushed into the nebulizer cup (580). As the carrier air passes over the surface of the solution (513) in the nebulizer cup (580), the carrier air can carry the droplets produced by the nebulizer (570) upward to the droplet size selection system (518).

The size selection system (518) can remove and recycle droplets greater than a selected droplet diameter, as well as assure droplet-vapor equilibrium. The selected droplet diameter is one that can be transported to the drying system (530). The selected droplet diameter should be of such a size that it can be dried by the drying system (530). It is typically beneficial to generate and selectively transport finer (smaller) droplets because they dry more rapidly and require less drying air than larger droplets. The determination of the desired droplet size can be based, at least in part, on the desired dried salt diameter. As is shown in the equations below, it is believed that the resulting salt diameter is directly proportional to the droplet size.

For example, depending on the solution concentration, the nebulizer could generate a mixture of droplets from less than 5 μm in size to over 20 μm in size. If the preferred droplet size range is 5 μm or less, the size-selection chamber should be configured to remove all droplets greater than 5 μm in size. The droplet size selection system can include two main parts: a shield, and a size-selecting mechanism.

The shield can be any of various shapes (e.g., inverted cone, inverted hemisphere, etc.), but it should be positioned in the way of large droplets (661) that are ejected from the solution surface with enough momentum that they would be carried to the size-selecting mechanism without the aid of carrier air. For example, the shield can be an inverted cone (662), as illustrated in FIG. 10. The inverted cone (662) can be centrally located within the chamber above the solution (513) in the nebulizer cup (580) and supported by support members such as pins (not shown), thereby allowing the carrier air to carry other droplets (663) up and around the inverted cone (662). The particles that impact the inverted cone (662) can be allowed to flow downward so that they are recycled back into the solution (513). The impaction of these particles is typically driven by the energy of the nebulization process, rather than the carrier gas. The carrier airflow can carry the remaining entrained droplets (663) around the inverted cone (662) and into a settling chamber (664).

The size-selecting mechanism can control the removal of droplets of a specific size. Two examples of types of size-selecting mechanisms that may be employed separately or in combination by the QAG are settling and impaction. In one embodiment, a settling chamber (664) is used. The settling chamber (664) should be tall enough to allow a laminar flow to be achieved within the chamber (664). For example, the ratio of the height of the chamber (664) to the diameter of the chamber (664) could be about 8:1. In this approach to size selection, the velocity of the carrier air through the settling chamber (664) determines the droplet size that is transported. The heavier (larger) droplets (665) settle out of the airflow (because the upward force of the carrier air on the large droplets is less than the downward force of gravity on the droplets) and are recycled back to the solution (513). The lighter (smaller) droplets (667) are transported by the carrier gas to the drying area of the QAG. As an example, a flow rate range for settling may be from about 0.1 to about 10 lpm for a settling chamber (664) with an inside diameter of about 0.85 inch, depending on the desired maximum droplet size. Flow rates corresponding to particular droplet sizes can be found in standard lookup tables and/or determined by experimentation. As the concentration of droplets increases, coagulation of droplets in the settling chamber (664) may become a concern at slower velocities. The flow rate of carrier air can be controlled in the carrier air control system (516), as discussed above.

Instead of, or in addition to, the settling chamber (664), one or more cyclone or flat plate impactors could be used. Such impactors are a well-known technology used for particle size-selection in many air-sampling applications. In such impactors, large droplets collide with an impactor and small droplets are carried past the impactor by main airflow (which can be, for example, approximately 5 lpm). The velocity of the carrier air should be greater than the impaction velocity of the droplets to be removed from the airstream. Different impactors and flow rates may be used to optimize the apparatus for different droplet sizes.

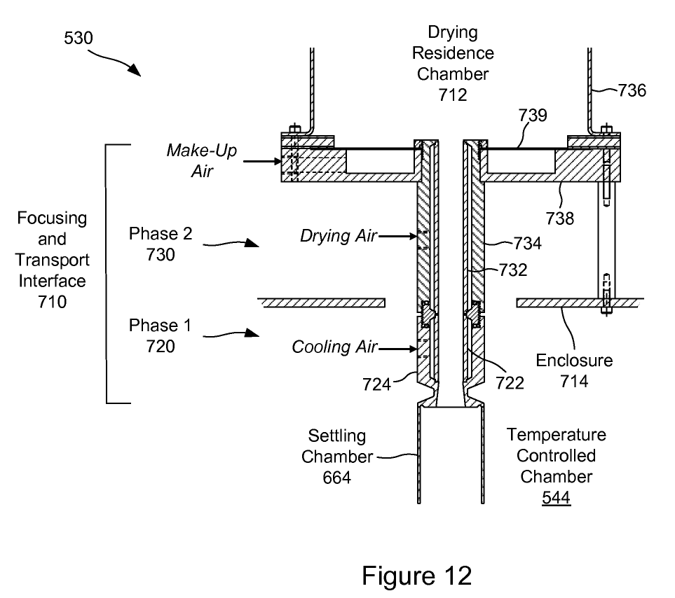

Referring to FIGS. 6 and 12, the remaining small droplets can equilibrate with water vapor in the settling chamber (664) and pass into the drying system (530). A standard thermocouple (not shown) can be located in the settling chamber (664) to measure the temperature of the carrier air/aerosol.

This drying system (530) can dry the liquid droplets into salt particles, producing the dry aerosol (540). This system can include a focusing and transport interface (710), a drying residence chamber (712), and heaters and heater controllers, as discussed in more detail below. The focusing and transport interface (710) and the drying residence chamber (712) could be incorporated into one chamber, as discussed below. Heated portions of the drying system (530) can be housed within an insulated enclosure (714) (see FIGS. 6 and 12), rather than the temperature-controlled chamber (544). The drying system (530) should prevent the loss of material to the walls, and the velocity of air through the system should exceed the droplet and dried salt settling velocity.

In the QAG with a Collison nebulizer, the relatively large (e.g., 20 μm) droplets generated by the Collison nebulizer can take a long time to dry, and a significant amount of drying air may be needed (e.g., 30 to about 100 lpm). As described above, that drying air could come into contact with the droplets through a drying air ring located just above the droplet size-selection plate of the embodiment described above with reference to FIGS. 1-4. As noted, in that embodiment the drying air enters the drying chamber through a series of holes in the ring. The drying air is oriented in parallel with the saturated air in order to act as a sheath that keeps the droplets from hitting the chamber walls. Proper mixing of the dry air with the saturated air and residence time for such a configuration typically requires a long chamber, such as a long 8-inch diameter drying chamber cylinder. That approach can have some drawbacks: (1) the cross-section of area above the size-selection chamber can have a high humidity, low temperature gradient (i.e., the center of the cylinder can have a significantly higher humidity and lower temperature than near the perimeter), requiring more drying time; (2) the large volume of drying air required can perturb overall sample volume significantly; (3) the orientation of drying air can prevent significant mixing; and (4) the large drying chamber can be cumbersome, reducing the ease of use.

Referring now to FIGS. 6 and 12, the focusing and transport interface (710) of the current embodiment can provide an interface between the settling chamber (664) and the drying residence chamber (712). The interface (710) can include two phases.

The first phase, a cooling air phase (720), extends up from the settling chamber (664). The cooling air phase (720) can have a hollow inner cylinder (722) made of a porous material such as sintered metal, which can be sintered steel. A non-porous hollow outer cylinder (724) can surround the inner cylinder (722), so that a chamber is defined between the outer cylinder (724) and the inner cylinder (722). The dry cooling air can be pushed into this chamber, and flow through the sintered metal of the inner cylinder (722) into the main aerosol flow within the inner cylinder (722) at an angle to the main flow such as about a right angle. The cooling air can flow at a rate of about 2 lpm or some other flow that is sufficient for its drying and cooling purpose, so as to create a non-turbulent airflow around the droplet aerosol from the size selection chamber such that these droplets are prevented from reaching the containing walls. This cooling air can begin drying the cold, saturated air from the size selection system (518). The flow of the cooling air through the inner cylinder (722) can create a laminar flow that focuses the droplets away from the walls of the inner cylinder (722) and improves the diffusional mixing characteristics of the cooling air with the main flow. The design of the cooling air phase (720) can also insulate the size-selection chamber from the heat of the drying residence chamber (712) and the second phase of the focusing and transport interface (710), a drying air phase (730), to minimize evaporative loss in the size selection system (518).

The drying air phase (730) can be located between the cooling air phase (720) of the interface (710) and the drying residence chamber (712). The drying air phase (730) can have an inner cylinder (732) made of a porous material such as sintered metal (such as steel), and a non-porous outer cylinder (734). The sintered metal inner cylinder (732) can produce the same benefits as in the first phase (720). In the second phase (730), hot, dry air can be emitted into the main airflow through the inner cylinder (732) at an angle to the aerosol flow such as about a right angle. The drying air can flow at a desirable rate, such as about 5 lpm. This air can be used to heat and further dry the cold air that comes from the first phase (720) of the interface (710).

The nebulized liquid droplets from the size selection system (518) can begin drying in the focusing and transport interface (710), as described above. The droplets can continue to dry in the drying residence chamber (712), and the resulting aerosol (540) can be emitted into a system or adapter for transmission to a system for analyzing the aerosol, or to some other system.

Referring still to FIGS. 6 and 12, the drying residence chamber (712) can include a heated transport pipe (736) extending up from a bottom plate (738). Heated make-up air can be passed into a void within the bottom plate (738). The void can be covered by a porous plate (739), such as a sintered metal (such as steel) plate. Thus, the make-up air can pass from the void in the bottom plate (738), through the porous plate (739), and into the drying residence chamber (712). This can allow more time for complete drying of the droplets if necessary.

Because the focused ultrasonic nebulizer and size-selector combination can generate droplets that are less than 5 μm in diameter, less drying air and residence time may be required for proper drying of droplets and a drying residence chamber may not be necessary in some situations. The drying residence chamber size can depend on the concentration and size of the droplets emitted from the size selection system (518). The drying residence chamber (712) could also be an extension of the second phase (730) of the focusing and transport interface (710) by elongating the inner cylinder (732) and adding the heated make-up air through the inner cylinder (732). The drying residence chamber (712) can be heated with a pair of standard blanket heaters (740) to an elevated temperature sufficient to dry the aerosol, such as about 350 degrees F.

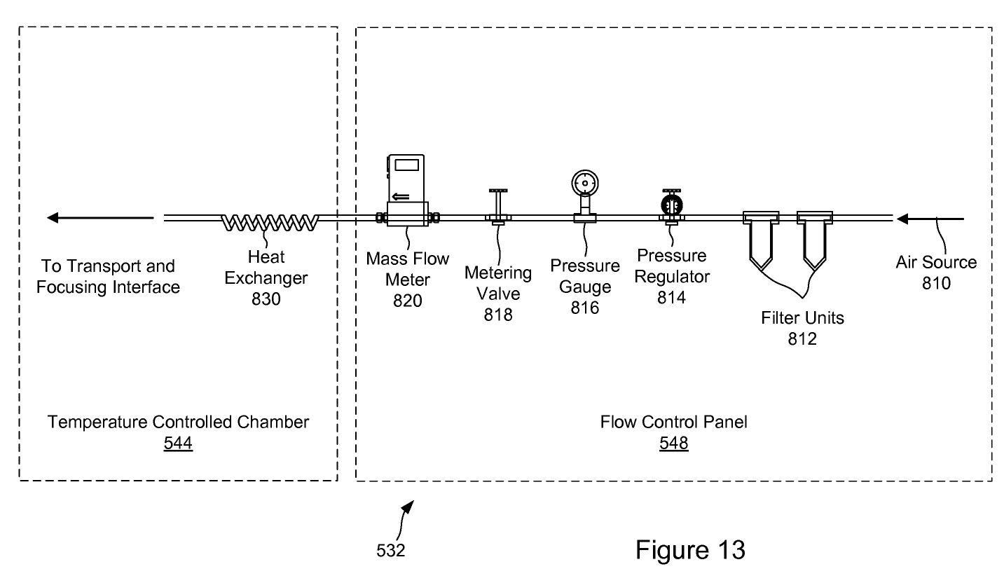

Referring now to FIG. 13, the cooling air control system (532) will be described. This system of the QAG (510) produces compressed air for cooling the main airflow in the first phase (720) of the focusing and transport interface (710) described above.

Stainless steel, PFA or some other tubing can be used to transport the cooling air through the cooling air control system (532). The cooling air control system (532) can include a clean dry air source (810), such as an air compressor in a clean indoor room. The air from the air source (810) can be passed through a pair of standard air filter units (812) to clean the air. The filter units (812) can be filter units that can remove water, particulate and oil vapor from the cooling air. The cooling air can then be passed through a standard precision pressure regulator (814) to regulate the pressure of the air. The pressure regulator (814) can maintain the pressure downstream of the regulator (814) at a selected pressure, such as a pressure from about 10 to about 50 psi. The cooling air can then be passed through a standard pressure gauge (816) to allow a user to monitor the air pressure downstream of the pressure regulator (814). The air can also be passed through a standard metering valve (818), which can be used to control the flow of cooling air entering the first phase (720) of the focusing and transport interface (710) (see FIG. 12). A standard mass flow meter (820) can be used to measure and display the current mass flow of cooling air. With this information, a user can use the metering valve (818) to produce a desired mass flow rate of cooling air. Alternatively, a critical orifice device or some other device could be used to control flow. As has been discussed above, the cooling air flow rate should be sufficient to produce the desired cooling, drying, and transport effect. The components of the cooling air system (532) described above can be located outside the temperature-controlled chamber (544).

Downstream of the mass flow meter (820), the cooling air can be passed through a heat exchanger (830) inside the temperature-controlled chamber (544) to bring the temperature of the cooling air to or near the temperature of the temperature-controlled chamber (544). The heat exchanger (830) can simply be a series of heat-conducting air lines wound in coils or some other configuration. Alternatively, some other type of heat exchanger could be used, such as a heat exchanger including fins or other features to facilitate heat exchange between the cooling air and the air in the temperature-controlled chamber (544).

The cooling air can be passed from the heat exchanger (830) into the chamber between the inner cylinder (722) and the outer cylinder (724) of the cooling air phase (720) of the focusing and transport interface (710), and thereby forced through the inner cylinder (722) and into contact with the main aerosol flow inside the inner cylinder (722).

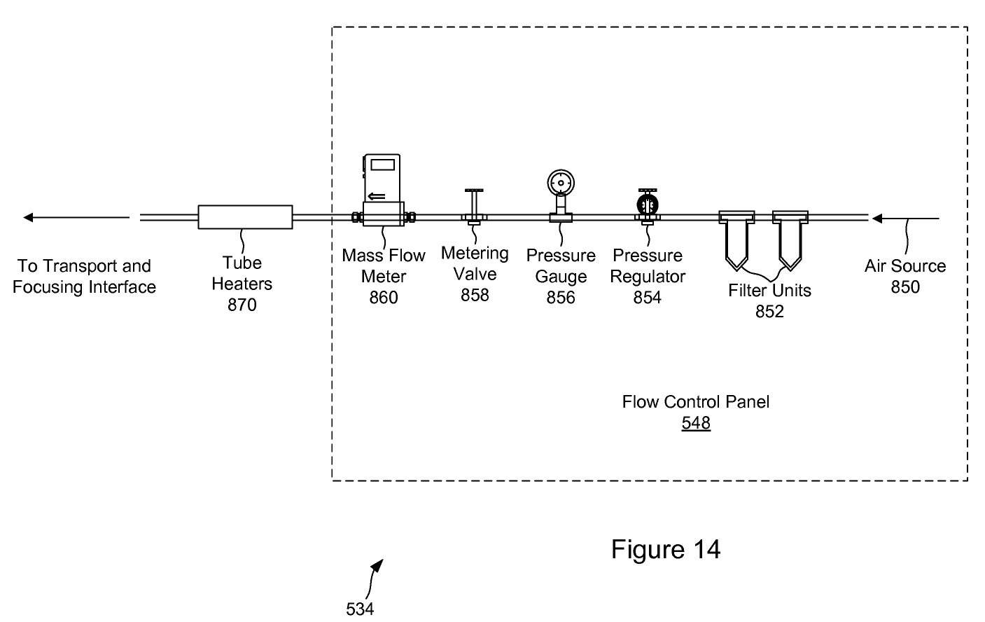

Referring to FIG. 14, the drying air control system (534) can control and heat compressed drying air for mixing and drying the liquid aerosol into salt particles in the second phase (730) of the focusing and transport interface (710) (see FIG. 12).

Stainless steel, PFA or some other tubing can be used to transport the drying air through the drying air control system (534). The drying air control system (534) can include a clean dry air source (850), such as an air compressor in a clean indoor room. The air from the air source (850) can be passed through a pair of standard air filter units (852) to clean the air. The filter units (852) can be filter units that can remove water, particulate and oil vapor from the drying air. The drying air can then be passed through a standard precision pressure regulator (854) to regulate the pressure of the air. The pressure regulator (854) can maintain the pressure downstream of the regulator (854) at a selected pressure, such as a pressure from about 10 to about 50 psi. The drying air can then be passed through a standard pressure gauge (856) to allow a user to monitor the air pressure downstream of the pressure regulator (854). The air can also be passed through a standard metering valve (858), which can be used to control the flow of heating air entering the second phase (730) of the focusing and transport interface (710) (see FIG. 12). A standard mass flow meter (860) can be used to measure and display the current mass flow of drying air. With this information, a user can use the metering valve (858) to produce a desired mass flow rate of drying air. Alternatively, a critical orifice device or some other device could be used to control flow. As has been discussed above, the drying airflow rate should be sufficient to produce the desired heating, drying, and transport effect. The components of the drying air control system (534) described above can be located outside the temperature-controlled chamber (544), such as in the flow control panel (548).

In one embodiment, the drying air can be passed through one or more standard tube heaters (870) downstream of the mass flow meter (860). However, other heaters and/or heat exchangers can be used to heat the air. The tube heaters (870) should be configured in number, position, type, and settings to heat the drying air to a sufficient temperature to perform its desired drying function. In one embodiment, the drying air is heated to about 350 degrees F. From the tube heaters (870), the drying air can be passed into the chamber between the inner cylinder (732) and the outer cylinder (734) of the second phase (730) of the focusing and transport interface (710) (see FIG. 12).

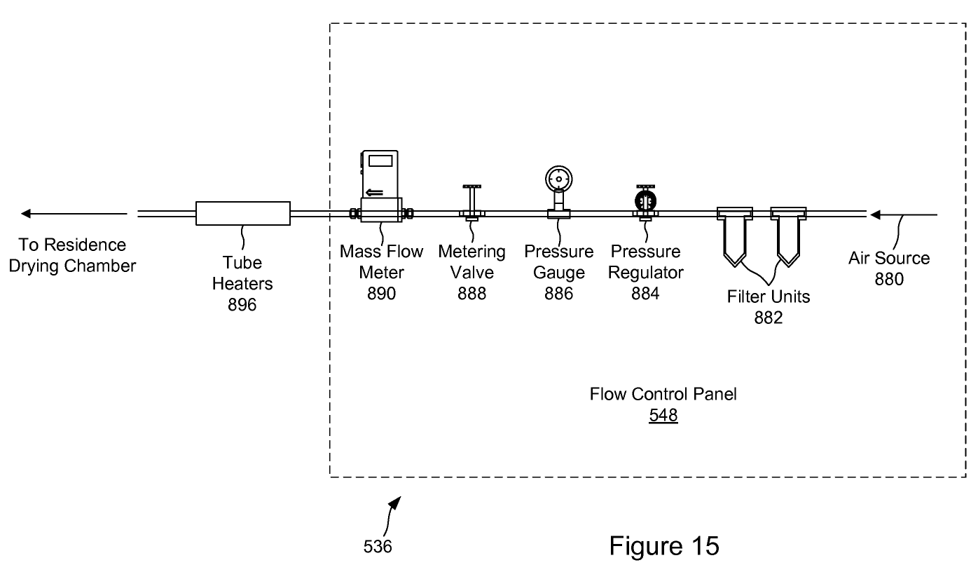

Referring to FIG. 15, the make-up air control system (536) controls and heats compressed air for further mixing and drying the liquid aerosol into salt particles. This air can also be used to achieve the flow requirements of downstream end-use equipment.

Stainless steel, PFA or some other tubing can be used to transport the drying air through the make-up air control system (536). The make-up air control system (536) can include a clean dry air source (880), such as an air compressor in a clean indoor room. The air from the air source (880) can be passed through a pair of standard air filter units (882) to clean the air. The filter units (882) can be filter units that can remove water, particulate and oil vapor from the drying air. The make-up air can then be passed through a standard precision pressure regulator (884) to regulate the pressure of the air. The pressure regulator (884) can maintain the pressure downstream of the regulator (884) at a selected pressure, such as a pressure from about 10 to about 50 psi. The make-up air can then be passed through a standard pressure gauge (886) to allow a user to monitor the air pressure downstream of the pressure regulator. The air can also be passed through a standard metering valve (888), which can be used to control the flow of make-up air entering the drying residence chamber (712). A standard mass flow meter (890) can be used to measure and display the current mass flow of drying air into the drying residence chamber (712) (see FIG. 6). With this information, a user can use the metering valve (888) to produce a desired mass flow rate of make-up air. Alternatively, a critical orifice device, or some other device could be used to control flow. As has been-discussed above, the make-up airflow rate should be sufficient to produce the desired heating, drying, and transport effect. The components of the make-up air control system (536) described above can be located outside the temperature-controlled chamber (544), such as in the flow control panel (548).

The make-up air can be passed through one or more standard tube heaters (896) downstream of the mass flow meter (890). The tube heaters (896) should be configured in number, position, type, and settings to heat the make-up air to a sufficient temperature to perform its desired drying function. In one embodiment, the drying air is heated to about 350 degrees F. From the tube heaters (896), the make-up air can be passed into the chamber between bottom plate (738) and the porous plate (739) of the drying residence chamber (712) (see FIG. 12).

Standard gaskets and other seals can be included between the components of the QAG (510). In addition, the different parts of the QAG (510) can be secured together in conventional ways, such as with pins and/or threaded fasteners. Throughout the QAG (510), the components that are in contact with wet solution can be made of non-corrosive material, or coated with non-corrosive material, such as PFE or stainless steel.

It is believed that the following calculations may be used to determine the solute concentration, mass emission rate, mass emission rate uncertainty, and size of aerosol particles for the QAG (510). However, it should be kept in mind that the invention is not limited by these equations, and the QAG (510) is useful even if other equations or methods are used to calculate desired parameters related to the QAG (510).

The following equation may be used to calculate the concentration (Cᵢ^{α-QAG} in μg/l) of the ith element in the quantitative aerosol (540) of the QAG (510) from the QAG's recorded parameters:

$${C}_{i}^{a \text{-} QAG} = \frac{{R}_{i}^{a \text{-} QAG}}{{F}^{a \text{-} QAG}} \qquad ( Equation 3 )$$

where:

F^{a-QAG}=Sum of the flow rates of the carrier air, drying air, make-up air, and cooling air in lpm.

Rᵢ^{a-QAG}=Mass emission rate of the i^{th} element (Rᵢ^{a-QAG}) in μg/min, calculated according to the following equation:

Rᵢ^{a-QAG}=Cᵢ^{s-QAG}(Rₘ−Rᵥ) (Equation 4)

where:

Cᵢ^{s-QAG}=Concentration of the i^{th} element in the QAG's solution (513) (μg/g).

Rₘ=Measured rate of reservoir mass loss, determined as the slope of a linear least squares fit of the reservoir mass data over the period of a test or series of tests (g/min).

Rᵥ=The rate of vapor loss. The rate of vapor loss (converted from mg/min to g/min) can be calculated from the following equation:

Rᵥ=Fₙm_{w} (Equation 5)

where:

Fₙ=Flow rate of carrier air (slpm).

m_{w}=Mass of water lost from the nebulizing air (mg/l), calculated from the following equation:

m_{w}=m_{T}_{ₛ}−m_{T}_{ₙ} (Equation 6)

where:

m_{T}_{ₛ}=Mass of water in a liter of air at Tₛ (mg/l), taken from a standard look-up table. Tₛ=Temperature of the carrier air at the size-selection chamber.

m_{T}_{ₙ}=Mass of water in a liter of air at Tₙ (mg/l), taken from a standard look-up table. Tₙ=Temperature of the carrier air at saturation. Note that if the temperature of the carrier air at the size selection chamber equals the temperature of the carrier air at saturation, then m_{T}_{ₛ}=m_{T}_{ₙ}, and Rᵥ (rate of vapor loss) is substantially zero (i.e., the vapor loss, if any, is substantially zero). This is typically substantially the case when an ultrasonic nebulizer is used and a constant temperature chamber is used to keep the temperatures substantially constant, as in the QAG (510) above.

The uncertainty of the mass emission rate (σ_{R}_{ᵢ}_{^{a-QAG}}) can be determined using standard propagation of error techniques relevant to the parameters of the mass emission rate equation above. The uncertainty values for the parameters can be those listed as certified uncertainties by the manufacturers and/or NIST. The uncertainty (σ_{R}_{ᵢ}_{^{a-QAG}}) of the mass emission rate (Rᵢ^{a-QAG}) may be calculated using the following equation:

$${σ}_{{R}_{i}^{a \text{-} QAG}} = {R}_{i}^{a \text{-} QAG} \sqrt{{( \frac{{σ}_{{C}_{i}^{s \text{-} QAG}}}{{C}_{i}^{s \text{-} QAG}} )}^{2} + {( \frac{{σ}_{( {R}_{m} - {R}_{v} )}}{( {R}_{m} - {R}_{v} )} )}^{2}} \qquad ( Equation 7 )$$

where:

σ_{(R}_{ₘ}_{-R}_{ᵥ}₎=\sqrt{(σ_{R}_{ₘ})²+(σ_{R}_{ᵥ})²} (Equation 8)

where:

σ_{(R}_{ᵥ}₎=\sqrt{(σ_{F}_{ₙ})²+(σₘ_{_{w}})²} (Equation 9)

where:

$${σ}_{( {m}_{w} )} = \sqrt{{( {σ}_{{M}_{{T}_{s}}} )}^{2} + {( {σ}_{{m}_{{T}_{n}}} )}^{2}} \qquad ( Equation 10 )$$

The following equation may be used to determine the size of the salt particles emitted by the QAG:

$${D}_{salt} = {D}_{liq} \sqrt[3]{( \frac{{C}_{i}^{s \text{-} QAG} {ρ}_{liq}}{{ρ}_{salt}} )} \qquad ( Equation 11 )$$

where:

Dₛₐₗₜ=The diameter of the salt in μm.

D_{liq}=The diameter of the liquid droplets in μm.

Cᵢ^{s-QAG}=The concentration of the analyte standard in the solution (513) in grams of analyte salt per gram of solution (513).

ρₛₐₗₜ=The density of the analyte salt in g/cm³.

ρ_{liq}=The density of the liquid droplet in g/cm³.

While the invention has been described by reference to the preferred embodiments described above, those skilled in the art will recognize that the invention as described and illustrated can be modified in arrangement and detail without departing from the scope of the invention.

I claim:

1. A method comprising:
nebulizing a liquid comprising an analyte to produce droplets of the liquid;
entraining the droplets in a carrier fluid flow;
selecting a portion of the droplets to remain entrained in the carrier fluid flow, thereby producing a selected droplet fluid flow including the carrier fluid and the selected portion of the droplets;
drying the selected droplet fluid flow to produce an aerosol flow containing particles comprising the analyte; and
quantifying an amount of the liquid consumed in producing the aerosol flow.

2. The method of claim 1, wherein drying the selected droplet fluid flow comprises mixing the selected droplet fluid flow with a first drying fluid stream at a first temperature and a second drying fluid stream at a second temperature that is higher than the first temperature.

3. The method of claim 2, wherein the first temperature is approximately equal to a temperature of the selected droplet fluid flow before being mixed with the first drying fluid stream or the second drying fluid stream.

4. The method of claim 1, wherein nebulizing comprises passing one or more ultrasonic waves through the liquid.

5. The method of claim 1, wherein drying the selected droplet fluid flow comprises introducing a flow of drying fluid into the selected droplet fluid flow.

6. The method of claim 5, wherein the flow of drying fluid focuses the selected droplet fluid flow toward a central region of a flow chamber.

7. The method of claim 5, wherein the flow of drying fluid is introduced through a porous member.

8. The method of claim 7, wherein the porous member is positioned around the selected droplet fluid flow.

9. The method of claim 5, wherein the flow of drying fluid is introduced to the selected droplet fluid flow at an angle relative to a direction of the selected droplet fluid flow.

10. The method of claim 9, wherein the angle is substantially a right angle.

11. The method of claim 1, wherein a temperature of the carrier fluid flow before having droplets entrained in the carrier fluid flow is substantially the same as a temperature of the selected droplet fluid flow prior to drying the selected droplet fluid flow.

12. The method of claim 1, wherein the analyte contains no waters of hydration, is non-deliquescent, is non-hygroscopic, and has a solubility of about 10% or more in the liquid.

13. The method of claim 12, wherein the analyte has a solubility of about 30% or more in the liquid.

14. The method of claim 12, wherein the analyte has a solubility of about 50% or more in the liquid.

15. The method of claim 12, wherein the analyte comprises a substance selected from a group consisting of potassium iodide, potassium sulfate, and rubidium sulfate.

16. The method of claim 1, further comprising spiking a gas stream with the aerosol flow containing particles comprising the analyte, wherein the analyte contains no waters of hydration, is non-deliquescent, is non-hygroscopic, has a solubility of about 10% or more in the liquid, and is not chemically-reactive with the gas stream.

17. The method of claim 16, wherein the analyte comprises a substance selected from a group consisting of potassium sulfate and rubidium sulfate.

18. An apparatus comprising:
a source of a liquid comprising an analyte;
a measurement device configured to measure a quantity of the liquid consumed by the apparatus;
a nebulizer system in communication with the source of liquid, the nebulizer system comprising a droplet generation chamber;
a source of carrier fluid;
a mixing region configured to mix the carrier fluid with droplets generated by the nebulizer system to form an aerosol flow containing droplets of the liquid entrained in the carrier fluid;
a droplet selection system in communication with the mixing region and configured to receive the aerosol flow; and
a drying system in communication with the droplet selection system and adapted to receive the aerosol flow therefrom, and to heat and dry the aerosol flow.

19. The apparatus of claim 18, wherein the drying system is configured to pass a drying fluid stream through a porous member to the aerosol flow.

20. The apparatus of claim 19, wherein the porous member is positioned around the aerosol flow.

21. The apparatus of claim 18, wherein the drying system comprises:
a first phase configured to mix the aerosol flow with a first drying fluid stream; and
a second phase configured to mix the aerosol flow with a second drying fluid stream.

22. The apparatus of claim 21, wherein the first drying fluid stream is at a first temperature and the second drying fluid stream is at a second temperature that is greater than the first temperature.

23. The apparatus of claim 22, wherein the first temperature is approximately equal to a temperature of the aerosol flow before the aerosol flow enters the first phase of the drying system.

24. The apparatus of claim 18, wherein the nebulizer system comprises an ultrasonic nebulizer.

25. The apparatus of claim 24, wherein the ultrasonic nebulizer comprises a nebulizer lens having a concave surface focused at a region at or adjacent to a surface of the liquid.

26. The apparatus of claim 24, wherein the ultrasonic nebulizer comprises a corrosive-resistant nebulizer lens.

27. The apparatus of claim 26, wherein the nebulizer lens comprises titanium.

28. The apparatus of claim 18, wherein the drying system comprises a focusing and transport system, the focusing and transport system being configured to focus and transport the aerosol flow by introducing a drying fluid at an angle to the fluid flow.

29. A method comprising:
providing a solution including a component therein;
forming a plurality of liquid droplets containing the component by applying one or more ultrasonic waves to the solution;
passing the liquid droplets through a droplet size selection system; and
drying a first portion of the liquid droplets to evaporate liquid therefrom.

30. The method of claim 29, further comprising quantifying the first portion of the liquid droplets.

31. The method of claim 29, wherein the one or more ultrasonic waves is applied by vibrating a lens comprising titanium.

32. The method of claim 29, wherein the ultrasonic waves are focused at a region at or near a surface of the solution.

33. The method of claim 29, wherein drying the first portion of the liquid droplets comprises mixing the first portion of the liquid droplets with a first fluid stream at a first temperature and with a second fluid stream at a second temperature that is higher than the first temperature.

34. The method of claim 33, wherein the first temperature is approximately equal to a temperature of the first portion of the liquid droplets before being mixed with the first fluid stream or the second fluid stream.
